(19) United States
(12) Patent Application Publication
(10) Pub. No.: US 2024/0131576 A1
(43) Pub. Date: Apr. 25, 2024

(54) COMPOSITE MOLD, METAL MOLDED ARTICLE, AND METHOD FOR MANUFACTURING SAME

(71) Applicant: POINT ENGINEERING CO., LTD., Chungcheongnam-do (KR)

(72) Inventors: Bum Mo AHN, Gyeonggi-do (KR); Seung Ho PARK, Gyeonggi-do (KR); Sung Hyun BYUN, Gyeonggi-do (KR)

(73) Assignee: POINT ENGINEERING CO., LTD., Chungcheongnam-do (KR)

(21) Appl. No.: 18/278,173

(22) PCT Filed: Feb. 21, 2022
(86) PCT No.: PCT/KR2022/002511

§ 371 Date: Aug. 20, 2023

(30) Foreign Application Priority Data
Feb. 22, 2021 (KR) 10-2021-0023268

(51) Int. Cl. B22C 9/20; B22D 19/16

(52) U.S. Cl. CPC B22C 9/20; B22D 19/16

(57) ABSTRACT

Proposed are a highly reliable metal molded article manufactured using a combination of a mold made of an anodic aluminum oxide film and a patternable mold, and a method for manufacturing the same.

### TECHNICAL FIELD

The present disclosure relates to a composite mold, a metal molded article, and a method for manufacturing the same.

### RELATED ART

The present disclosure relates to a method for manufacturing a metal molded article, a part of which has a dimensional range of several tens of micrometers, by using a combination of a mold made of an anodic aluminum oxide film and a patternable mold, and to a metal molded article manufactured thereby.

Hereinafter, an electrically conductive contact pin will be described as an example of the above metal molded article. A test for electrical characteristics of a semiconductor device is performed by approaching an object to be inspected (semiconductor wafer or semiconductor package) to an inspection apparatus having a plurality of electrically conductive contact pins and then bringing the electrically conductive contact pins into contact with corresponding electrode pads (or solder balls or bumps) on the object to be inspected. After the electrically conductive contact pins reach positions where they are brought into contact with the electrode pads on the object to be inspected, a process of further approaching the object to be inspected is performed. This process is called overdrive. Overdrive is a process that elastically deforms the electrically conductive contact pins. By overdrive, all electrically conductive contact pins can be reliably brought into contact with the electrode pads even when there is a height difference between the electrode pads or the electrically conductive contact pins. During overdrive, each electrically conductive contact pin is elastically deformed, and performs scrubbing while a tip thereof moves on an electrode pad. By such scrubbing, an oxide film on a surface of the electrode pad can be removed and contact resistance can be reduced thereby.

In the manufacture of contact pins, a method of manufacturing contact pins using laser technology is generally used. For example, there is a method of manufacturing contact pins by cutting a substrate made of a conductive material with a laser beam. The laser beam cuts the substrate along a predetermined profile corresponding to each contact pin and forms sharp edges on the contact pin through different operations. However, such laser cutting technology for manufacturing contact pins by cutting a metal sheet along a profile corresponding to the final shape of each contact pin has limitations in improving the dimensional accuracy of the contact pin. Also, since the contact pins have to be cut individually with a laser beam, a problem arises in that the production speed of the contact pins is reduced.

Meanwhile, contact pins may be manufactured using an MEMS process. A process of manufacturing a contact pin using the MEMS process involves first applying a photoresist film to a surface of a conductive substrate and then patterning the photoresist film. After that, a metal material is deposited on the exposed surface of the conductive substrate within openings by electroplating using the photoresist film as a mold, and the photoresist film and the conductive substrate are removed to obtain contact pins. The contact pins thus manufactured using the MEMS process are referred to as MEMS contact pins. The shape of these MEMS contact pins is the same as that of the openings formed in the photoresist film mold. In this case, the thickness of the MEMS contact pins is affected by the height of the photoresist film mold.

When using a photoresist film as a mold for electroplating, it is difficult to sufficiently increase the height of the mold only with the use of a single-layer photoresist film. As a result, it is also difficult to sufficiently increase the thickness of the contact pins. The MEMS contact pins need to be manufactured with a predetermined thickness in consideration of electrical conductivity, restoring force, brittle fracture, etc. In order to increase the thickness of the MEMS contact pins, a mold in which photoresist films are stacked in multiple layers may be used. In this case, however, since each photoresist film layer is slightly stepped, a side surface of each contact pin is not formed vertically and a stepped area minutely remains. In addition, when the photoresist films are stacked in multiple layers, it is difficult to accurately reproduce the shape of the contact pins having a dimension range of equal to or less than several tens of μm.

### DOCUMENTS OF RELATED ART

### Patent Documents

(Patent Document 1) Korean Patent Application Publication No. 10-2018-0004753

### SUMMARY OF INVENTION

### Technical Problem

Accordingly, the present disclosure has been made keeping in mind the above problems occurring in the related art, and an objective of the present disclosure is to provide a highly reliable metal molded article manufactured using a combination of a mold made of an anodic aluminum oxide film and a patternable mold, a method for manufacturing the same, and a composite mold used therefor.

### Technical Solution

In order to accomplish the above objective, one aspect of the present disclosure provides a method of manufacturing a metal molded article, the method including: preparing a composite mold by stacking a second mold made of a patternable material on one surface of a first mold made of an anodic aluminum oxide film; and forming a metal molded article by filling a plurality of openings of the composite mold with a metal material.

In addition, the metal molded article may be formed by plating by providing a lower metal layer under the composite mold.

Meanwhile, another aspect of the present disclosure provides a method of manufacturing a metal molded article including a first metal layer and a second metal layer, the method including: forming the first metal layer using a first mold made of an anodic aluminum oxide film; and forming the second metal layer using a second mold made of a patternable material.

In addition, the material of the second mold may be a photoresist film.

In addition, the first metal layer may be formed in a first opening of the first mold by plating, and a second metal layer may be formed in a second opening of the second mold by plating.

Meanwhile, another aspect of the present disclosure provides a metal molded article having a first surface, a second surface opposite to the first surface, and a side surface connecting the first surface and the second surface to each other. Here, a side surface area located at at least a partial height of the side surface may include a fine trench, unlike a side surface area located at another height.

In addition, at least one end of the metal molded article may include a protruding tip portion having a cross-sectional area smaller than a cross-sectional area of a central portion of a body portion.

In addition, the tip portion may be made of a material different from a material of the body portion.

In addition, the tip portion may have the same width as the central portion of the body portion, but have a lower height than the central portion of the body portion.

In addition, the tip portion may have the same height as the central portion of the body portion, but have a narrower width than the central portion of the body portion.

In addition, the tip portion may be provided at a corner of the end of the metal molded article.

In addition, the tip portion may be provided at a center of the end of the metal molded article.

In addition, the tip portion may be made of a material having a higher hardness than the body portion.

Meanwhile, another aspect of the present disclosure provides a metal molded article having a first surface, a second surface opposite to the first surface, and a side surface connecting the first surface and the second surface to each other, the metal molded article including: a first side surface area located at a first height of the side surface of the metal molded article; and a second side surface area located at a second height of the side surface of the metal molded article. Here, the first side surface area may include a plurality of fine trenches formed side by side in a long groove shape extending from the first surface to the second surface.

In addition, the metal molded article may have a height in a range of 10 μm to 200 μm, and have a vertical side surface in which the first side surface area has a verticality in a range of 0.1° to 3°.

In addition, the fine trenches may have a depth in a range of 20 nm to 1 μm.

Meanwhile, another aspect of the present disclosure provides a metal molded article having a first surface, a second surface opposite to the first surface, and a side surface connecting the first surface and the second surface to each other, the metal molded article including: a first side surface area located at a first height of the side surface of the metal molded article; a second side surface area located above the first side surface area; and a third side surface area located below the first side surface area. Here, the first side surface area may include a plurality of fine trenches formed side by side in a long groove shape extending from the first surface to the second surface.

In addition, the first side surface area may be formed to protrude further than the second side surface area and the third side surface area.

Meanwhile, another aspect of the present disclosure provides a metal molded article having a first surface, a second surface opposite to the first surface, and a side surface connecting the first surface and the second surface to each other. Here, at least one end of the metal molded article may include a protruding tip portion having a cross-sectional area smaller than a cross-sectional area of a central portion of a body portion, and a side surface of the tip portion may include a plurality of fine trenches formed side by side in a long groove shape extending from the first surface to the second surface.

In addition, the metal molded article may be an electrically conductive contact pin.

Meanwhile, another aspect of the present disclosure provides a composite mold, including: a first mold made of an anodic aluminum oxide film; and a second mold made of a patternable material and provided on the first mold.

In addition, the material of the second mold may be a photoresist film.

In addition, the composite mold may further include: a first opening provided in the first mold; and a second opening provided in the second mold.

In addition, the first opening and the second opening may be formed to have the same width.

In addition, the composite mold may further include a lower metal layer provided under the first mold.

In addition, the composite mold may further include: a first island provided in the first opening; and a second island provided in the second opening.

### Advantageous Effects

The present disclosure provides a highly reliable metal molded article manufactured using a combination of a mold made of an anodic aluminum oxide film and a patternable mold, a method for manufacturing the same, and a composite mold used therefor.

### BRIEF DESCRIPTION OF DRAWINGS

FIG. 1 is a view illustrating a metal molded article and a method for manufacturing the same according to a first embodiment of the present disclosure.

FIG. 2 is a view illustrating a metal molded article according to a second embodiment of the present disclosure.

FIGS. 3 and 4 are views illustrating a method for manufacturing a metal molded article according to the second embodiment of the present disclosure.

FIG. 5 is a view illustrating a metal molded article according to a third embodiment of the present disclosure.

FIGS. 6 and 7 are views illustrating a method for manufacturing a metal molded article according to the third embodiment of the present disclosure.

FIG. 8 is a view illustrating a metal molded article according to a fourth embodiment of the present disclosure.

FIGS. 9 and 10 are views illustrating a method for manufacturing a metal molded article according to the fourth embodiment of the present disclosure.

FIG. 11 is a view illustrating a metal molded article according to a fifth embodiment of the present disclosure.

FIGS. 12 to 14 are views illustrating a method for manufacturing a metal molded article according to the fifth embodiment of the present disclosure.

FIG. 15 is a view illustrating a metal molded article according to a sixth embodiment of the present disclosure.

FIGS. 16 to 18 are views illustrating a method for manufacturing a metal molded article according to the sixth embodiment of the present disclosure.

FIG. 19 is an image illustrating a fine trench according to an embodiment of the present disclosure.

### DESCRIPTION OF EMBODIMENTS

### Mode for Invention

Contents of the description below merely exemplify the principle of the present disclosure. Therefore, those of ordinary skill in the art may implement the theory of the present disclosure and invent various apparatuses which are included within the concept and the scope of the present disclosure even though it is not clearly explained or illustrated in the description. Furthermore, in principle, all the conditional terms and embodiments listed in this description are clearly intended for the purpose of understanding the concept of the present disclosure, and one should understand that the present disclosure is not limited to the exemplary embodiments and the conditions.

The above described objectives, features, and advantages will be more apparent through the following detailed description related to the accompanying drawings, and thus those of ordinary skill in the art may easily implement the technical spirit of the present disclosure.

The embodiments of the present disclosure are described with reference to cross-sectional views and/or perspective views which schematically illustrate ideal embodiments of the present disclosure. For explicit and convenient description of the technical content, sizes or thicknesses of films and regions in the figures may be exaggerated. Therefore, variations from the shapes of the illustrations as a result, for example, of manufacturing techniques and/or tolerances, are to be expected. In addition, a limited number of molded articles are illustrated in the drawings by way of example. Thus, the embodiments should not be construed as limited to the particular shapes of regions illustrated herein but are to include deviations in shapes that result, for example, from manufacturing.

Wherever possible, the same reference numerals will be used throughout different embodiments and the description to refer to the same or like elements or parts. In addition, the configuration and operation already described in other embodiments will be omitted for convenience.

A metal molded article according to an embodiment of the present disclosure refers to an article having a predetermined thickness, height, and length. The metal molded article according to the embodiment of the present disclosure may be manufactured by MEMS technology, and may be applied to various fields depending on its use.

The metal molded article according to the embodiment of the present disclosure includes an electrically conductive contact pin for inspecting an object to be inspected. The electrically conductive contact pin is provided in an inspection apparatus and is used to transmit electrical signals by making electrical and physical contact with the object to be inspected. The inspection apparatus may be an inspection apparatus used in a semiconductor manufacturing process, for example, a probe card or a test socket depending on the type of an object to be inspected. However, the inspection apparatus according to the embodiment of the present disclosure is not limited thereto, and includes any apparatus for checking whether an object to be inspected is defective by applying electricity.

The metal molded article and a method for manufacturing the same according to the embodiment of the present disclosure have a technical feature in that a composite mold including a first mold made of an anodic aluminum oxide film and a second mold made of a patternable material is used. Preferably, the manufacture of the metal molded article is achieved by manufacturing the composite mold in advance and then forming a metal filler in openings of the composite mold. The metal filler may be formed by sequentially stacking the first mold made of the anodic aluminum oxide film and the second mold made of the patternable material according to a process order.

Since the composite mold according to the embodiment of the present disclosure adopts a mold made of an anodic aluminum oxide film, in the case of a metal molded article having a first surface, a second surface opposite to the first surface, and a side surface connecting the first surface and the second surface to each other, a side surface area located at at least a partial height of the side surface is provided with a fine trench, unlike a side surface area located at another height.

Hereinafter, exemplary embodiments of the present disclosure will be described in detail with reference to the accompanying drawings.

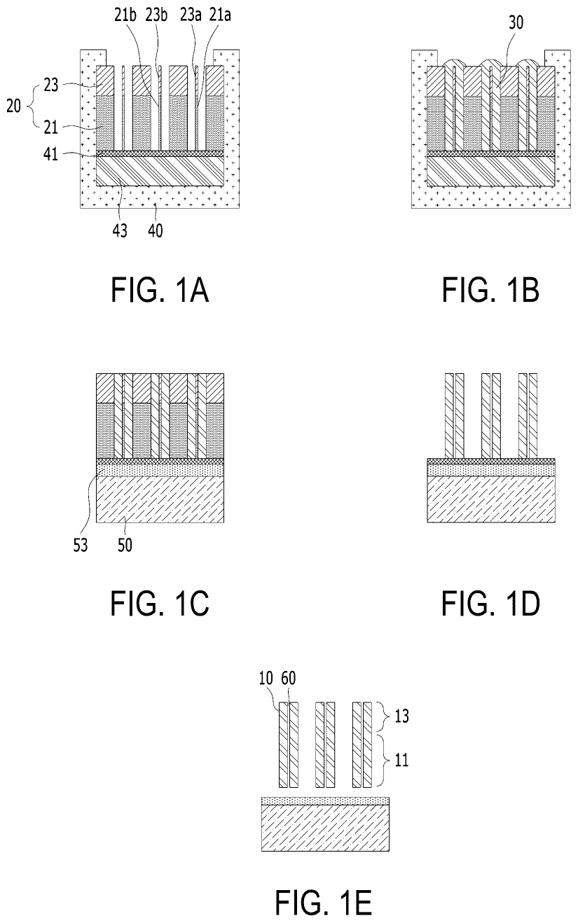

FIG. 1 is a view illustrating a metal molded article and a method for manufacturing the same according to a first embodiment of the present disclosure. The metal molded article and the method for manufacturing the same according to the first embodiment relates to a metal molded article manufactured by manufacturing a composite mold 20 in advance and then forming a metal filler 30 in openings of the composite mold 20, and to a method for manufacturing the same.

Referring to FIG. 1, the method for manufacturing the metal molded article 10 according to the first embodiment of the present disclosure is a method of manufacturing the metal molded article 10 by using a combination of a first mold 21 made of an anodic aluminum oxide film and a second mold 23 made of a patternable material 23. As illustrated in FIG. 1, the composite mold includes the first mold 21 made of the anodic aluminum oxide film and the second mold 23 made of the patternable material.

The first mold 21 made of the anodic aluminum oxide film means a film formed by anodizing a metal as a base material, and pores mean holes formed in the process of forming the anodic aluminum oxide film by anodizing the metal. For example, when the metal as the base material is aluminum (Al) or an aluminum alloy, the anodization of the base material forms the anodic aluminum oxide film consisting of anodized aluminum (Al₂O₃) on a surface of the base material. The resulting anodic aluminum oxide film includes a barrier layer in which no pores are formed therein vertically, and a porous layer in which pores are formed therein. After removing the base material on which the anodic aluminum oxide film having the barrier layer and the porous layer is formed, only the anodic aluminum oxide film consisting of anodized aluminum (Al₂O₃) remains. The anodic aluminum oxide film may have a structure in which the barrier layer formed during the anodization is removed to expose the top and bottom of the pores, or a structure in which the barrier layer formed during the anodization remains to close one of the top and bottom of the pores. The anodic aluminum oxide film has a coefficient of thermal expansion of 2 to 3 ppm/° C. With this range, the anodic aluminum oxide film only undergoes a small amount of thermal deformation due to temperature when exposed to a high temperature environment. Thus, even when the metal molded article 10 is manufactured in a high temperature environment, a precise electrically conductive contact pin 10 can be manufactured without thermal deformation.

The second mold 23 made of the patternable material is made of a material that can be subjected to exposure and development processes, and includes a photoresist film.

In the case of manufacturing the metal molded article 10 using only the second mold 23 made of the photoresist film, it is difficult to sufficiently increase the height of the mold only with the use of a single-layer photoresist film. As a result, it is also difficult to sufficiently increase the thickness of the metal molded article 10. The metal molded article 10 needs to be manufactured with a predetermined thickness in consideration of electrical conductivity, restoring force, brittle fracture, etc. In order to increase the thickness of the metal molded article 10, a mold in which photoresist films are stacked in multiple layers may be used. In this case, however, since each photoresist film layer is slightly stepped, a side surface of each metal molded article 10 is not formed vertically and a stepped area minutely remains. In addition, when the photoresist films are stacked in multiple layers, it is difficult to accurately reproduce the shape of the metal molded article 10 having a dimension range of equal to or less than several tens of μm.

Meanwhile, in the case of manufacturing the metal molded article 10 using the first mold 21 made of the anodic aluminum oxide film, it is advantageous in that it is possible to manufacture a metal molded article 10 having a vertical side surface. However, since the first mold 21 made of the anodic aluminum oxide film is manufactured through an anodization process, it takes a lot of time to make the height of the first mold sufficiently thick.

Therefore, the use of a combination of the first mold 21 made of the anodic aluminum oxide film and the second mold 23 made of the patternable material as a mold for electroplating makes it possible to manufacture a metal molded article 10 having a vertical side surface and excellent shape accuracy, and to compensate for an insufficient height of the first mold 21 made of the anodic aluminum oxide with the second mold 23 made of the patternable material. In addition, when using only the first mold 21 made of the anodic aluminum oxide film, it may be difficult to manufacture a metal molded article 10 having a three-dimensional shape in the height direction. However, the use of a combination of the first mold 21 made of the anodic aluminum oxide film and the second mold 23 made of the patternable material makes it easy to manufacture a metal molded article 10 having a three-dimensional shape in the height direction.

The second mold 23 made of the patternable material is provided on the first mold 21 made of the anodic aluminum oxide film. According to the configuration in which the second mold 23 made of the patternable material is disposed on the first mold 21 made of the anodic aluminum oxide film, the second mold 23 made of the patternable material protects the first mold 21 made of the anodic aluminum oxide film during a planarization process (chemical mechanical polishing (CMP)) after a plating process is completed, thereby preventing cracks from occurring.

The first mold 21 made of the anodic aluminum oxide film may be used to manufacture a basic shape of the metal molded article 10. The second mold 23 made of the patternable material may be used to manufacture a complex three-dimensional shape other than the basic shape or to increase the height of the basic shape.

A support member provided under the first mold 21 made of the anodic aluminum oxide film includes a first support member 40 provided under the first mold 21 made of the anodic aluminum oxide film in an electroplating process to support the composite mold 20, and a second support member 50 provided under the first mold 21 in a planarization process to support the composite mold 20.

Referring to FIG. 1(a), metal layers 41 and 43 are provided on an upper surface of the first support member 40. The metal layers 41 and 43 include a first lower metal layer 41 provided under the composite mold 20 and a second lower metal layer 43 provided on the upper surface of the first support member 40.

The first lower metal layer 41 is preferably made of copper (Cu), platinum (Pt), tantalum (Ta), titanium (Ti), or an alloy of these metals, but is not limited thereto as long as it is a material that functions as a seed layer for electroplating.

The second lower metal layer 43 is provided between the upper surface of the first support member 40 and the first lower metal layer 41, and may be made of copper (Cu), platinum (Pt), tantalum (Ta), titanium (Ti), or an alloy of these metals, preferably copper (Cu) having good electrical conductivity, but is not limited thereto. The second lower metal layer 43 is a configuration adopted to improve the uniformity of electroplating for each of a plurality of openings 21a and 23a of the composite mold 20. The second lower metal layer 43 is formed to be sufficiently thicker than the first lower metal layer 41 to supply a uniform current to each of the plurality of openings 21a and 23a of the composite mold 20 during electroplating.

The first lower metal layer 41 provided on a lower surface of the composite mold 20 may be provided before mounting the composite mold 20 to the first support member 40, and the second lower metal layer 43 provided on the first support member 40 may also be provided before mounting the composite mold 20 to the first support member 600.

Preparation for electroplating is completed by placing the composite mold 20 provided with the first lower metal layer 41 on an upper surface of the second lower metal layer 43 provided on the first support member 40 and then fixing the composite mold 20 to the first support member 40. A method of fixing the composite mold 20 to the first support member 40 includes fixing by a clamping means, fixing by an adhesive tape, etc. For example, a part of the upper surface of the composite mold 20 may be clamped by a clamping part provided on the first support member so that the composite mold 20 can be fixed without shaking.

The first mold 21 has a first opening 21a. A first island 21b made of an anodic aluminum oxide film is provided inside the first opening 21a. The first island 21b is an area where the anodic aluminum oxide film remains without being removed when the first opening 21a is formed by etching a portion of the first mold 21, and is an anodic aluminum oxide film area surrounded by the first opening 21a. The first mold 21 may have a thickness in the range of 10 μm to 100 μm. In terms of the fact that the first mold 21 is used to manufacture the basic shape of the metal molded article 10, the thickness of the first mold 21 ranges from 50 μm to 80 μm.

The second mold 23 has a second opening 23a. The second opening 23a may have the same width as the first opening 21a. A second island 23b made of a photoresist film is provided inside the second opening 23a. The second island 23b is an area where the photoresist film remains without being removed when the second opening 23a is formed by etching a portion of the second mold 23, and is a photoresist film area surrounded by the second opening 23a. The second mold 23 may have a thickness in the range of 10 μm to 100 μm. In terms of the fact that the second mold 23 is used to manufacture the three-dimensional shape of the metal molded article and is used for the purpose of increasing the height of the metal molded article, but the shape accuracy is reduced when the height is increased, the thickness of the second mold 23 ranges from lam to 50 μm.

Next, as illustrated in FIG. 1(b), electroplating is performed using the first and second lower metal layers 41 and 43. The second lower metal layer 43 functions as an electrode for electroplating, and the first lower metal layer 41 functions as a seed layer for electroplating. The metal filler 30 fills each of the first and second openings 21a and 21b of the composite mold 20, except for the islands 21b and 23b, from the bottom of the first opening 21a to the top of the second opening 23a.

After the electroplating is completed, as illustrated in FIG. 1(c), the composite mold 20 is separated from the first support member 40 and placed on an upper surface of the second support member 50, and then a planarization process is performed. In this case, when the composite mold 20 is separated from the first support member 40, the first lower metal layer 41 under the composite mold 20 is also separated from the first support member 40. A bonding layer 53 is provided on the upper surface of the second support member 50. The composite mold 20 can be fixed to the second support member 50 without shaking through the bonding layer 53. The metal filler 30 protruding from the upper surface of the composite mold 20 is then removed through a chemical mechanical polishing (CMP) process. Here, a portion of the upper surface of the second mold 23 is also removed in consideration of a designed thickness of the metal molded article 10.

Then, as illustrated in FIG. 1(d), the composite mold 20 is removed using an etchant. The second mold 23 made of the photoresist film is selectively removed first, and then the first mold 21 made of the anodic aluminum oxide film is selectively removed. At this time, the first and second islands 21b and 23b are also removed by the etchant. As a result of the removal of the first and second islands 21b and 23b, a hole 60 vertically passing through the inside of a metal molded article 10 is formed. The metal molded article 10 thus manufactured includes the hole 60 therein passing through the metal molded article 10 in the thickness direction thereof. The hole 60 is formed along the longitudinal direction of the metal molded article 10 inside the metal molded article 10 so that the metal molded article 10 can be more easily deformed by a pressing force.

Then, as illustrated in FIG. 1(e), the first lower metal layer 41 is removed using an etchant that selectively reacts to the first lower metal layer 41, thereby completing the manufacture of the metal molded article 10.

The metal molded article 10 has a first surface (upper surface), a second surface (lower surface) opposite to the first surface, and a side surface connecting the first surface and the second surface to each other. The metal molded article 10 includes a first side surface area 11 located at a first height of the side surface of the metal molded article 10 and a second side surface area 13 located at a second height of the side surface of the metal molded article 10. The first side surface area 11 of the metal molded article is formed using the first mold 21 made of the anodic aluminum oxide film, and the second side surface area 13 of the metal molded article 10 is formed using the second mold 23 made of the photoresist film. The first side surface area 11 formed using the first mold 21 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from the first surface (upper surface) to the second surface (lower surface) of the metal molded article.

The fine trenches 88 have a depth in the range of 20 nm to 1 μm and a width in the range of 20 nm to 1 μm. Here, because the fine trenches 88 are resulted from the formation of the pores formed during the manufacture of the first mold 21 made of the anodic aluminum oxide film, the width and depth of the fine trenches 88 are equal to or less than the diameter of the pores formed in the first mold 21 made of the anodic aluminum oxide film. Meanwhile, in the process of forming the opening in the first mold 21 made of the anodic aluminum oxide film, portions of the pores of the first mold 21 made of the anodic aluminum oxide film may be crushed by an etchant to at least partially form a fine trench 88 having a depth greater than the diameter of the pores formed during the anodization.

The fine trenches 88 as described above can contribute to increasing the surface area of the side surface of the metal molded article 10. In addition, the fine trenches 88 can improve torsional resistance when the metal molded article 10 is deformed. An electrically conductive contact pin, which is an embodiment of the metal molded article 10, slides in contact with an inner surface of a guide hole of a guide plate. When the electrically conductive contact pin receives a torsional load, the fine trenches 88 provided on a side surface of the electrically conductive contact pin to be parallel to a pressing surface enable the electrically conductive contact pin to withstand twisting. This prevents twisting of the electrically conductive contact pin from occurring and prevents a contact surface from being reduced during sliding, thereby minimizing generation of cutting foreign substances on the side surface. In addition, the fine trenches 88 can improve elastic restoring ability when the metal molded article 10 is deformed. In addition, the fine trenches 88 enable heat generated in the metal molded article 10 to be rapidly dissipated, thereby suppressing a rise in the temperature of the metal molded article 10.

The metal molded article 10 has a height in the range of 10 μm to 200 μm, and has a vertical side surface in which the first side surface area 11 has a verticality in the range of 0.1° to 3°.

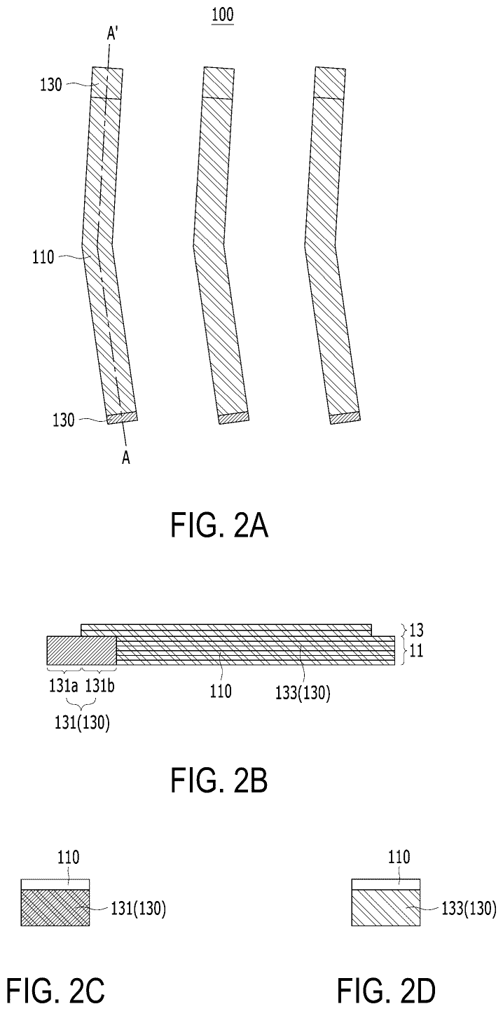

With reference to FIGS. 2 to 18, a process of manufacturing a metal molded article 100, 200, 300, 400, 500 by forming a metal filler by sequentially using a first mold made of an anodic aluminum oxide film and a second mold made of a patternable material according to a process order will be described.

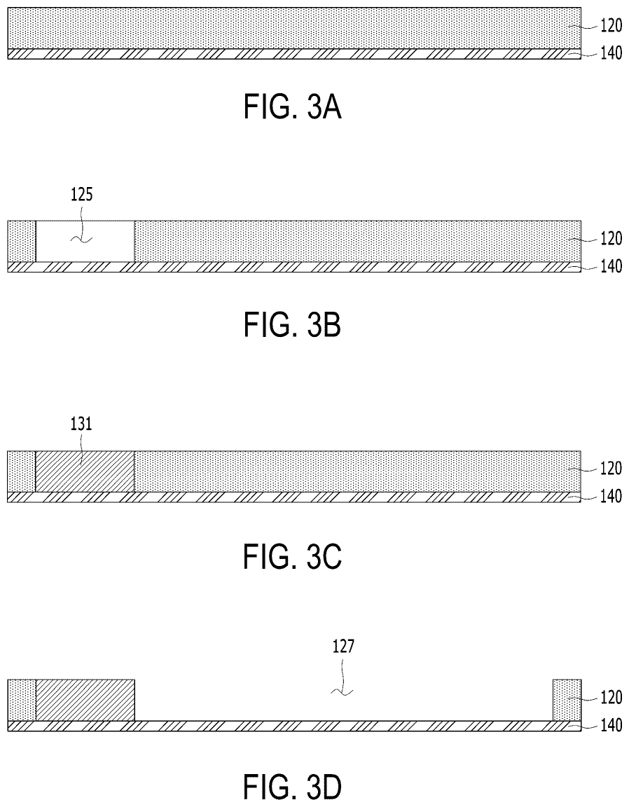

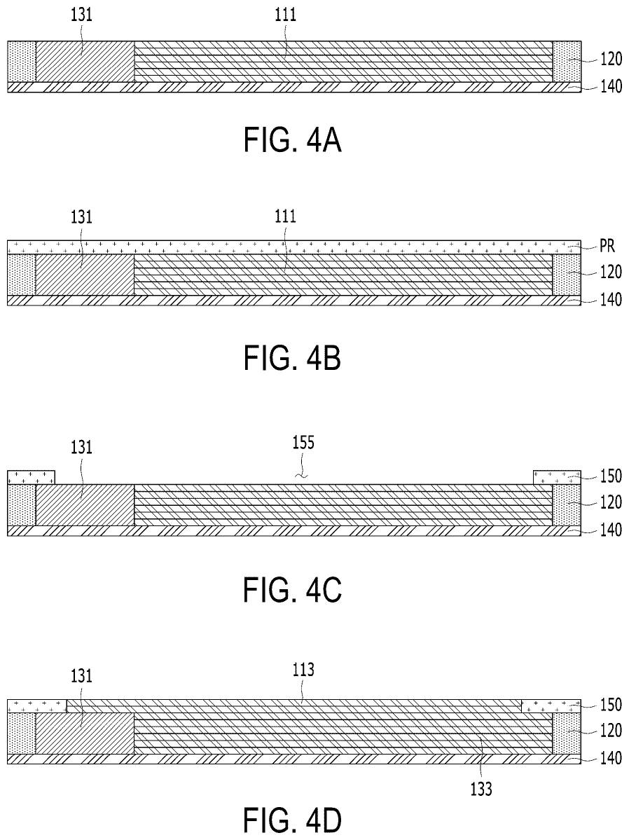

FIGS. 2 to 4 are views illustrating a metal molded article 100 and a method for manufacturing the same according to a second embodiment of the present disclosure. FIG. 2a is a plan view illustrating the metal molded article 100 according to the second embodiment, FIG. 2b is a sectional view taken along line A-A′ of FIG. 2a, FIG. 2c is a front view illustrating the metal molded article 100, and FIG. 2d is a rear view illustrating the metal molded article 100. FIGS. 3 and 4 are views illustrating the method for manufacturing the metal molded article 100 according to the second embodiment of the present disclosure.

Referring to FIG. 2, the metal molded article 100 includes a protruding tip portion 130 having a smaller cross-sectional area than a central portion of a body portion 110. The tip portion 130 has the same width as the central portion of the body portion 110, but has a lower height than the central portion of the body portion 110.

The metal molded article 100 may be made of a conductive material. Here, the conductive material may be at least one selected from the group consisting of platinum (Pt), rhodium (Ph), palladium (Pd), copper (Cu), silver (Ag), gold (Au), iridium (Ir), and an alloy of these metals, or the group consisting of a nickel-cobalt (NiCo) alloy, a palladium-cobalt (PdCo) alloy, a palladium-nickel (PdNi) alloy, and a nickel-phosphorus (NiP) alloy. The body portion of the metal molded article 100 may have a multilayer structure in which a plurality of conductive materials are stacked. The material of each of the conductive layers made of different materials may be selected from the group consisting of platinum (Pt), rhodium (Ph), palladium (Pd), copper (Cu), silver (Ag), gold (Au), iridium (Ir), and an alloy of these metals, or the group consisting of a palladium-cobalt (PdCo) alloy, a palladium-nickel (PdNi) alloy, and a nickel-phosphorus (NiP) alloy.

The tip portion 130 may be made of a material different from that of the body portion 110.

Since the tip portion 130 may function as a portion substantially brought into contact with an object to be inspected, the tip portion 130 may be made of a material having a relatively higher hardness than the body portion 110. As an embodiment, the tip portion 130 may be made of palladium (Pd) or rhodium (Ph). Meanwhile, the body portion 110 may be made of at least one of a material having relatively higher electrical conductivity and a material having relatively higher elasticity than the tip portion 130. The body portion 110 may be formed by stacking the plurality of conductive materials. Therefore, the meaning that the tip portion 130 is made of a material having a relatively higher hardness than the body portion 110 may mean that the tip portion 130 is made of a material having a higher hardness than the average hardness of the body portion 110.

Referring to FIG. 2, tip portions 130 are provided at opposite ends of the metal molded article 100. A first tip portion 131 provided at a first end of the metal molded article is made of a material different from that of the body portion 110, and a second tip portion 133 provided at a second end of the metal molded article is made of the same material as that of the body portion 110. The first tip portion 131 is formed through a plating process separate from that for the body portion 110, so that the material of the first tip portion 131 is different from that of the body portion 110. The second tip portion 133 is formed during the plating process for the body portion 110, so that the material of the second tip portion 133 is the same as that of the body portion 110.

The central axis of each of the tip portions 130 is located eccentrically from the central axis of the body portion 110. With the configuration in which the central axis of each of the tip portions 130 is eccentric from the central axis of the body portion 110, the metal molded article 100 can be more effectively deformed when compressed by a pressing force. Thus, it is possible to reduce the contact pressure on the object to be inspected.

An eccentric direction of the central axis of the first tip portion 131 with respect to the central axis of the body portion 110 may be the same as an eccentric direction of the central axis of the second tip portion 131 with respect to the central axis of the body portion 110. In detail, the central axis of the first tip portion 131 is located below the central axis of the body portion 110, and the central axis of the second tip portion 131 is also located below the central axis of the body portion 110. Thus, it is possible to make a bending direction of the metal molded article 100 constant by allowing the metal molded article 100 to be bent in the opposite direction to the eccentric directions.

The first tip portion 131 includes a protruding portion 131a protruding outward from the body portion 110 of the metal molded article 100 and a buried portion 131b located inside the body portion 110 of the metal molded article 100. With the configuration of the buried portion 131b, the first tip portion 131 made of a material different from that of the body portion 110 is prevented from being separated from the body portion 110.

With reference to FIGS. 3 and 4, the method for manufacturing the metal molded article 100 according to the second embodiment of the present disclosure will be described.

Referring to FIG. 3a, first, a first mold 120 made of an anodic aluminum oxide film is prepared. A seed layer 140 is provided under the first mold 120 made of the anodic aluminum oxide film. The seed layer 140 is formed under the first mold 120 in advance for subsequent electroplating.

Referring to FIG. 3b, a first opening 125 is formed in the first mold 120 made of the anodic aluminum oxide film. The first opening 125 may be formed by removing at least a portion of the first mold 120 made of the anodic aluminum oxide film. The first opening 125 may be formed by etching the first mold 120 made of the anodic aluminum oxide film. To this end, a photoresist may be provided on an upper surface of the first mold 120 made of the anodic aluminum oxide film and patterned, and then the anodic aluminum oxide film in a patterned and open area may react with an etchant to form the first opening 125. In detail, a photosensitive material may be provided on the upper surface of the first mold 120 made of the anodic aluminum oxide film in a state before the first opening 125 is formed, and then subjected to exposure and development processes. At least a portion of the photosensitive material may be patterned and removed through the exposure and development processes to form an open area. The first mold 120 made of the anodic aluminum oxide film is subjected to an etching process in the open area from which the at least the portion of the photosensitive material has been removed by patterning, thereby forming the first opening 125. In addition, when the first mold 120 made of the anodic aluminum oxide film is subjected to wet etching with an etchant, a first opening 125 having a vertical inner wall is formed. As described above, forming a plating layer using the anodic aluminum oxide film as a mold as compared to using a photoresist as a mold can improve the accuracy of the shape of the plating layer, so that a metal molded article 100 having a precise microstructure can be manufactured.

Referring to FIG. 3c, a first tip portion 131 is formed in the first opening 125 by plating. During electroplating, the first tip portion 131 is formed using the seed layer 140. After the plating process is completed, a planarization process is performed. The plating layer protruding from an upper surface of the first mold 120 made of the anodic aluminum oxide film is removed and planarized through a chemical mechanical polishing (CMP) process.

Referring to FIG. 3d, a second opening 127 for forming a first body 111 is formed. The second opening 127 may be formed by removing at least a portion of the first mold 120 made of the anodic aluminum oxide film. The second opening 127 may be formed by etching the first mold 120 made of the anodic aluminum oxide film.

Referring to FIG. 4a, the first body 111 is formed in the second opening 127 by plating. The first body portion 111 may have a multilayer structure in which metal layers of different materials are stacked. At least one metal layer of the multilayer structure may be made of a material having high electrical conductivity, and another metal layer of the multilayer structure may be made of a material having high elasticity. As such, by forming the first body portion 111 in a multilayer structure, it is possible to manufacture a metal molded article 100 having high electrical conductivity and high elasticity. After the plating process is completed, a planarization process is performed.

Referring to FIG. 4b, a photoresist PR is formed.

Referring to FIG. 4c, a second mold 150 made of a photoresist film is formed by patterning the photoresist PR. The second mold 150 made of the photoresist film has a third opening 155 formed during patterning of the photoresist. The second mold 150 made of the photoresist film is formed while covering a portion of an upper surface of the first tip portion 131 provided at the first end of the metal molded article so that the upper surface of the first tip portion 131 is not exposed entirely, and while covering a portion of an upper surface of the body portion 111 provided at the second end of the metal molded article so that the upper surface of the body portion is not exposed entirely.

Referring to FIG. 4d, a second body portion 113 is formed in the third opening 155 by plating. The second body portion 113 constitutes the body portion 110 together with the previously formed first body portion 111. Then, the second mold 150 made of the photoresist film, the first mold 120 made of the anodic aluminum oxide film, and the seed layer 140 are removed, thereby completing a metal molded article 100. The metal molded article 100 thus manufactured has first and second tip portions 131 and 133 at opposite ends thereof, respectively. The first tip portion 131 provided at the first end of the metal molded article is made of a material different from that of the body portion 110, and the second tip portion 133 provided at the second end of the metal molded article is made of the same material as that of the body portion 110.

A bonding force of the first tip portion 131 with the body portion 110 is increased by the configuration of a buried portion 131b. Thus, the first tip portion 131 is prevented from being separated from the body portion 110.

A first side surface area 11 of the metal molded article 100 is formed using the first mold 120 made of the anodic aluminum oxide film, and a second side surface area 13 of the metal molded article 100 is formed using the second mold 150 made of the photoresist film. The first side surface area 11 formed using the first mold 120 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from a first surface (upper surface) to a second surface (lower surface) of the metal molded article.

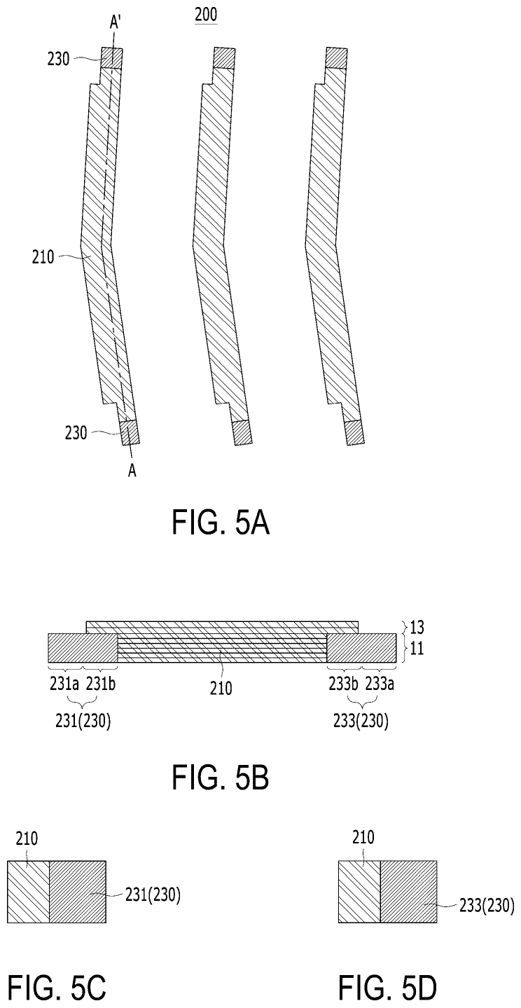

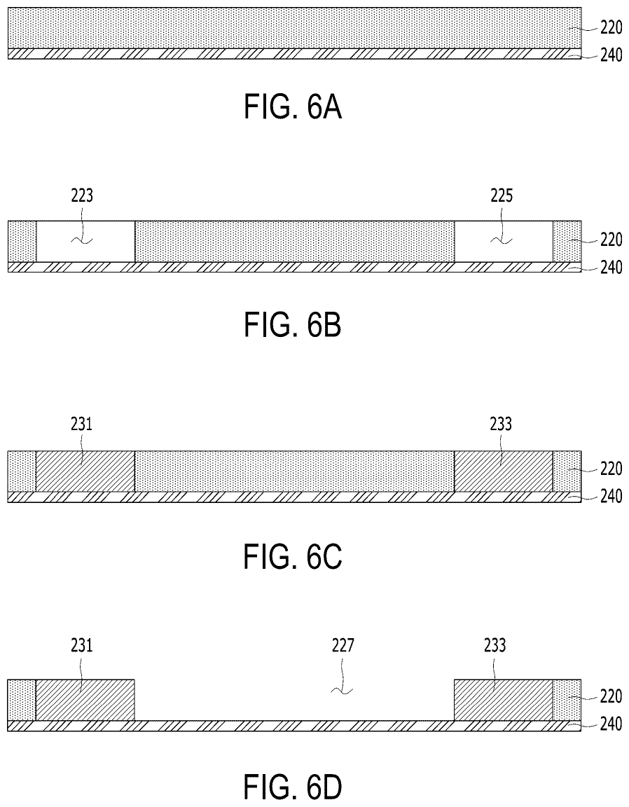

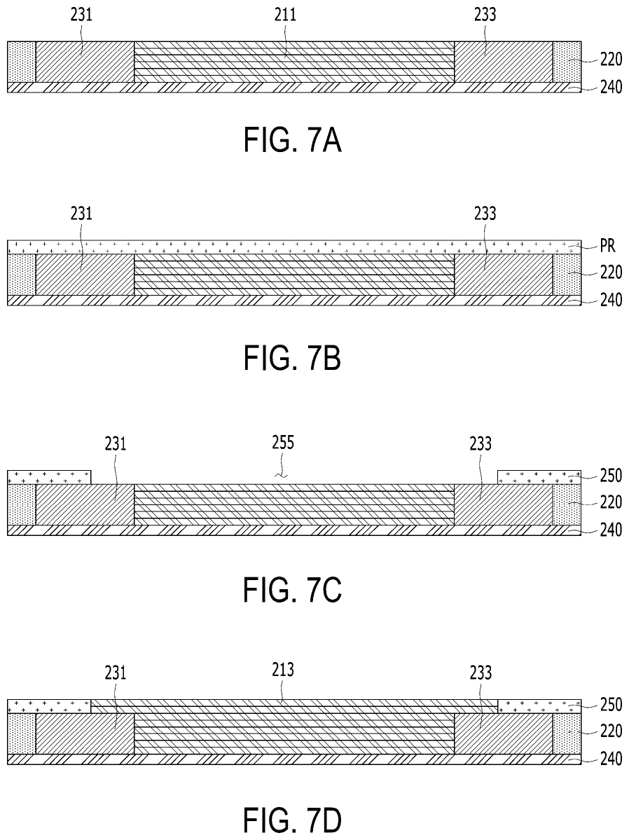

FIGS. 5 to 7 are views illustrating a metal molded article 200 and a method for manufacturing the same according to a third embodiment of the present disclosure. FIG. 5a is a plan view illustrating the metal molded article 200 according to the third embodiment, FIG. 5b is a sectional view taken along line A-A′ of FIG. 5a, FIG. 5c is a front view illustrating the metal molded article 200, and FIG. 5d is a rear view illustrating the metal molded article 200. FIGS. 6 and 7 are views illustrating the method for manufacturing the metal molded article 200 according to the third embodiment of the present disclosure.

Referring to FIG. 5, the metal molded article 200 includes a protruding tip portion 230 having a smaller cross-sectional area than a central portion of a body portion 210. When a tip portion 230 has the same height as a central portion of the body portion 210 but has a narrower width than the central portion of the body portion 210, the tip portion 230 is provided to be biased toward one side of the body portion 210.

Tip portions 230 are provided at opposite ends of the metal molded article 200. A first tip portion 231 provided at a first end of the metal molded article is made of a material different from that of the body portion 210, and a second tip portion 233 provided at a second end of the metal molded article is also made of a material different from that of the body portion 210.

Since the central axis of each of the tip portions 230 is eccentric from the central axis of the body portion 210, the metal molded article 200 can be more effectively deformed when compressed by a pressing force. Thus, it is possible to reduce the contact pressure on an object to be inspected.

An eccentric direction of the central axis of the first tip portion 231 with respect to the central axis of the body portion 210 may be the same as an eccentric direction of the central axis of the second tip portion 231 with respect to the central axis of the body portion 210. In detail, the central axis of the first tip portion 131 is located to the right of the central axis of the body portion 110, and the central axis of the second tip portion 131 is also located to the right of the central axis of the body portion 110. Thus, it is possible to make a bending direction of the metal molded article 200 constant by allowing the metal molded article 200 to be bent in the opposite direction to the eccentric directions.

The first tip portion 231 includes a protruding portion 231a protruding outward from the body portion 210 of the metal molded article 200 and a buried portion 231b located inside the body portion 210 of the metal molded article 200. Also, the second tip portion 233 includes a protruding portion 233a protruding outward from the body portion 210 of the metal molded article 200 and a buried portion 233b located inside the body portion 210 of the metal molded article 200. With the configuration of the buried portions 231b and 233b, the first and second tip portions 231 and 233 made of a material different from that of the body portion 210 are prevented from being separated from the body portion 210.

With reference to FIGS. 6 and 7, the method for manufacturing the metal molded article 200 according to the second embodiment of the present disclosure will be described.

Referring to FIG. 6a, first, a first mold 220 made of an anodic aluminum oxide film is prepared. A seed layer 240 is provided under the first mold 220 made of the anodic aluminum oxide film. The seed layer 240 is formed under the first mold 220 in advance for subsequent electroplating.

Referring to FIG. 6b, first and second openings 223 and 225 are formed in the first mold 220 made of the anodic aluminum oxide film. The first and second openings 223 and 225 may be formed by removing at least portions of the first mold 220 made of the anodic aluminum oxide film. The first and second openings 223 and 225 may be formed by etching the first mold 220 made of the anodic aluminum oxide film. To this end, a photoresist may be provided on an upper surface of the first mold 220 made of the anodic aluminum oxide film and patterned, and then the anodic aluminum oxide film in patterned and open areas may react with an etchant to form the first and second openings 223 and 225. In detail, a photosensitive material may be provided on the upper surface of the first mold 220 made of the anodic aluminum oxide film in a state before the first and second openings 223 and 225 are formed, and then subjected to exposure and development processes. At least portions of the photosensitive material may be patterned and removed through the exposure and development processes to form open areas. The first mold 220 made of the anodic aluminum oxide film is subjected to an etching process in the open areas from which the at least portions of the photosensitive material have been removed by patterning, thereby forming the first and second openings 223 and 225. In addition, when the first mold 220 made of the anodic aluminum oxide film is subjected to wet etching with an etchant, first and second openings 223 and 225 having vertical inner walls are formed. As described above, forming a plating layer using the anodic aluminum oxide film as a mold as compared to using a photoresist as a mold can improve the accuracy of the shape of the plating layer, so that a metal molded article 200 having a precise microstructure can be manufactured.

Referring to FIG. 6c, first and second tip portions 231 and 233 are formed in the first and second openings 223 and 225 by plating. During electroplating, the first and second tip portions 231 and 233 are formed using the seed layer 240. After the plating process is completed, a planarization process is performed. The plating layer protruding from an upper surface of the first mold 220 made of the anodic aluminum oxide film is removed and planarized through a chemical mechanical polishing (CMP) process.

Referring to FIG. 6d, a third opening 227 for forming a first body 211 is formed. The third opening 227 may be formed by removing at least a portion of the first mold 220 made of the anodic aluminum oxide film. The third opening 227 may be formed by etching the first mold 220 made of the anodic aluminum oxide film.

Referring to FIG. 7a, a first body portion 211 is formed in the third opening 227 by plating. The first body portion 211 may have a multilayer structure in which metal layers of different materials are stacked. At least one metal layer of the multilayer structure may be made of a material having high electrical conductivity, and another metal layer of the multilayer structure may be made of a material having high elasticity. As such, by forming the first body portion 211 in a multilayer structure, it is possible to manufacture a metal molded article 200 having high electrical conductivity and high elasticity. After the plating process is completed, a planarization process is performed.

Referring to FIG. 7b, a photoresist PR is formed.

Referring to FIG. 7c, a second mold 250 made of a photoresist film is formed by patterning the photoresist PR. The second mold 250 made of the photoresist film has a fourth opening 255 formed during patterning of the photoresist. The second mold 250 made of the photoresist film is formed while covering a portion of an upper surface of the first tip portion 231 provided at the first end of the metal molded article so that the upper surface of the first tip portion 231 is not exposed entirely, and while covering a portion of an upper surface of the second tip portion 233 provided at the second end of the metal molded article so that the upper surface of the second tip portion 233 is not exposed entirely.

Referring to FIG. 7d, a second body portion 213 is formed in the fourth opening 255 by plating. The second body portion 213 constitutes the body portion 210 together with the previously formed first body portion 211. Then, the second mold 250 made of the photoresist film, the first mold 220 made of the anodic aluminum oxide film, and the seed layer 240 are removed, thereby completing a metal molded article 200. The metal molded article 200 thus manufactured has the first and second tip portions 231 and 233 at opposite ends thereof, respectively. The first and second tip portions 231 and 233 are made of a material different from that of the body portion 110.

A bonding force of the first and second tip portions 231 and 233 with the body portion 210 is increased by the configuration of buried portions 231b and 233b. Thus, the first and second tip portions 231 and 233 are prevented from being separated from the body portion 210. A first side surface area 11 of the metal molded article 200 is formed using the first mold 220 made of the anodic aluminum oxide film, and a second side surface area 13 of the metal molded article 200 is formed using the second mold 250 made of the photoresist film. The first side surface area 11 formed using the first mold 220 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from a first surface (upper surface) to a second surface (lower surface) of the metal molded article.

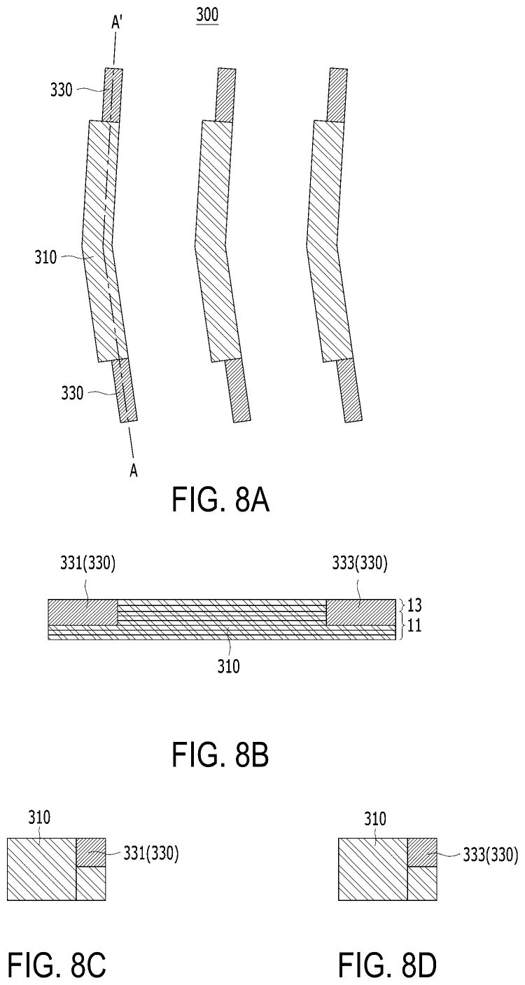

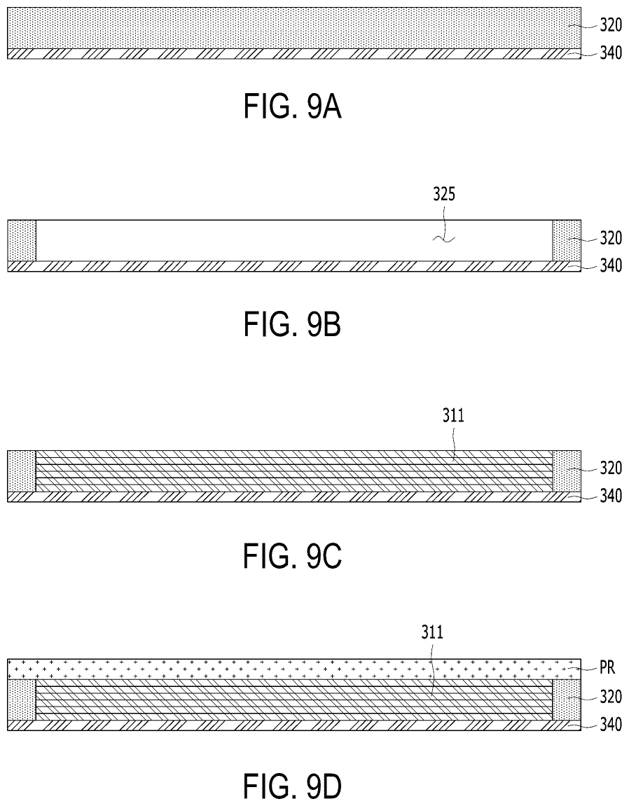

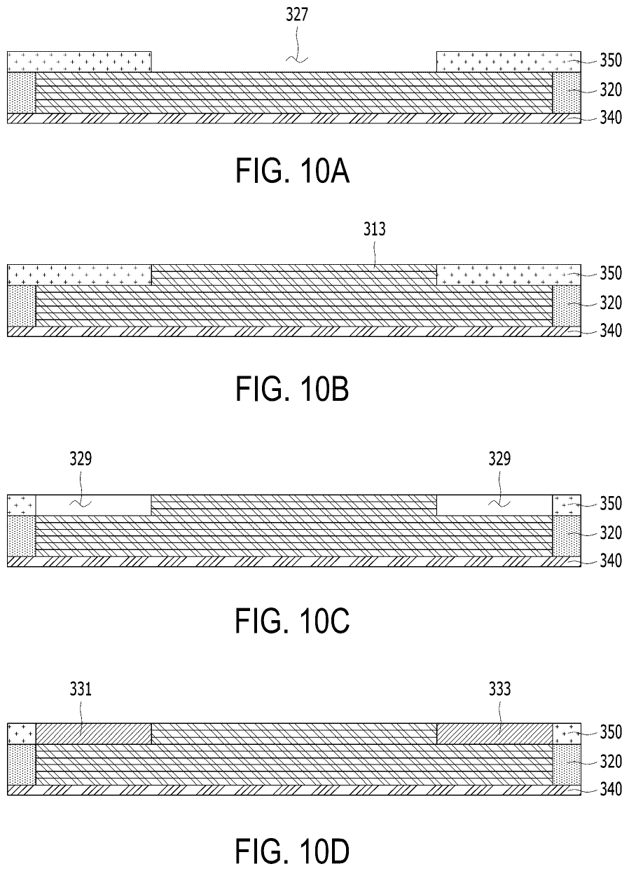

FIGS. 8 to 10 are views illustrating a metal molded article 300 and a method for manufacturing the same according to a fourth embodiment of the present disclosure. FIG. 8a is a plan view illustrating the metal molded article 300 according to the fourth embodiment, FIG. 8b is a sectional view taken along line A-A′ of FIG. 8a, FIG. 8c is a front view illustrating the metal molded article 300, and FIG. 8d is a rear view illustrating the metal molded article 300. FIGS. 9 and 10 are views illustrating the method for manufacturing the metal molded article 300 according to the fourth embodiment of the present disclosure.

Referring to FIG. 8, the metal molded article 300 includes a protruding tip portion 330 having a smaller cross-sectional area than a central portion of a body portion 310. The tip portion 330 is provided at a corner of an end of the metal molded article 300.

Referring to FIG. 8, tip portions 330 are provided at opposite ends of the metal molded article 300. A first tip portion 331 provided at a first end of the metal molded article is made of a material different from that of the body portion 210, and a second tip portion 233 provided at a second end of the metal molded article is also made of a material different from that of the body portion 210.

Since the central axis of each of the tip portions 330 is eccentric from the central axis of the body portion 310, the metal molded article 300 can be more effectively deformed when compressed by a pressing force. Thus, it is possible to reduce the contact pressure on an object to be inspected.

An eccentric direction of the central axis of the first tip portion 331 with respect to the central axis of the body portion 310 may be the same as an eccentric direction of the central axis of the second tip portion 231 with respect to the central axis of the body portion 310. In detail, the central axis of the first tip portion 331 is located above and to the right of the central axis of the body portion 310, and the central axis of the second tip portion 331 is also located above and to the right of the central axis of the body portion 310. Thus, it is possible to make a bending direction of the metal molded article 300 constant by allowing the metal molded article 300 to be bent in the opposite direction to the eccentric directions.

Since lower surfaces of the tip portions 330 are bonded to the body portion 310 protruding from the central portion of the body portion 310, the tip portions 330 are prevented from being separated from the body portion 310.

With reference to FIGS. 9 and 10, the method for manufacturing the metal molded article 300 according to the fourth embodiment of the present disclosure will be described.

Referring to FIG. 9a, first, a first mold 320 made of an anodic aluminum oxide film is prepared. A seed layer 340 is provided under the first mold 320 made of the anodic aluminum oxide film. The seed layer 340 is formed under the first mold 320 in advance for subsequent electroplating.

Referring to FIG. 9b, a first opening 325 is formed in the first mold 320 made of the anodic aluminum oxide film. The first opening 325 may be formed by removing at least a portion of the first mold 320 made of the anodic aluminum oxide film. The first opening 325 may be formed by etching the first mold 320 made of the anodic aluminum oxide film. To this end, a photoresist may be provided on an upper surface of the first mold 320 made of the anodic aluminum oxide film and patterned, and then the anodic aluminum oxide film in a patterned and open area may react with an etchant to form the first opening 325. In detail, a photosensitive material may be provided on the upper surface of the first mold 320 made of the anodic aluminum oxide film in a state before the first opening 325 is formed, and then subjected to exposure and development processes. At least a portion of the photosensitive material may be patterned and removed through the exposure and development processes to form an open area. The first mold 320 made of the anodic aluminum oxide film is subjected to an etching process in the open area from which the at least the portion of the photosensitive material has been removed by patterning, thereby forming the first opening 325. In addition, when the first mold 320 made of the anodic aluminum oxide film is subjected to wet etching with an etchant, a first opening 325 having a vertical inner wall is formed. As described above, forming a plating layer using the anodic aluminum oxide film as a mold as compared to using a photoresist as a mold can improve the accuracy of the shape of the plating layer, so that a metal molded article 300 having a precise microstructure can be manufactured.

Referring to FIG. 9c, a first body portion 311 is formed in the first opening 325 by plating. During electroplating, the first body portion 311 is formed using the seed layer 340. After the plating process is completed, a planarization process is performed. The plating layer protruding from an upper surface of the first mold 320 made of the anodic aluminum oxide film is removed and planarized through a chemical mechanical polishing (CMP) process.

Referring to FIG. 9d, a photoresist PR is formed.

Referring to FIG. 10a, a second mold 350 made of a photoresist film is formed by patterning the photoresist PR. The second mold 350 made of the photoresist film has a second opening 327 formed during patterning of the photoresist.

Referring to FIG. 10b, a second body portion 313 is formed in the second opening 327 by plating. The second body portion 313 constitutes the body portion 310 together with the previously formed first body portion 311.

Referring to FIG. 10c, a third opening 329 is formed by patterning the second mold 350 made of the photoresist film. Third openings 329 are provided at opposite end sides of the second mold.

Referring to FIG. 10d, the first and second tip portions 331 and 333 are formed in the third openings 329 by plating. Then, the second mold 350 made of the photoresist film, the first mold 320 made of the anodic aluminum oxide film, and the seed layer 340 are removed, thereby completing a metal molded article 300. The metal molded article 300 thus manufactured has the first and second tip portions 331 and 333 at opposite ends thereof, respectively. The first and second tip portions 331 and 333 are made of a material different from that of the body portion 310.

A first side surface area 11 of the metal molded article 300 is formed using the first mold 320 made of the anodic aluminum oxide film, and a second side surface area 13 of the metal molded article 300 is formed using the second mold 350 made of the photoresist film. The first side surface area 11 formed using the first mold 320 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from a first surface (upper surface) to a second surface (lower surface) of the metal molded article.

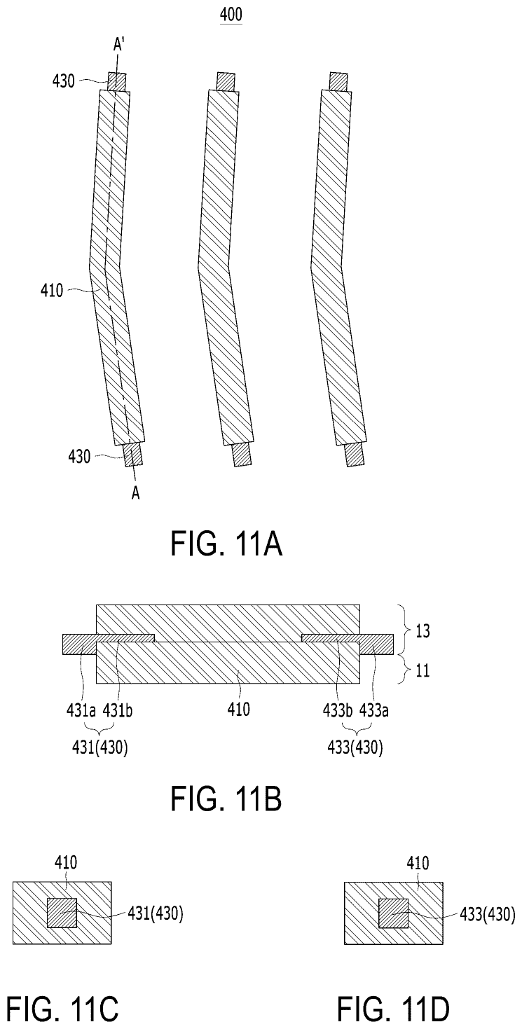

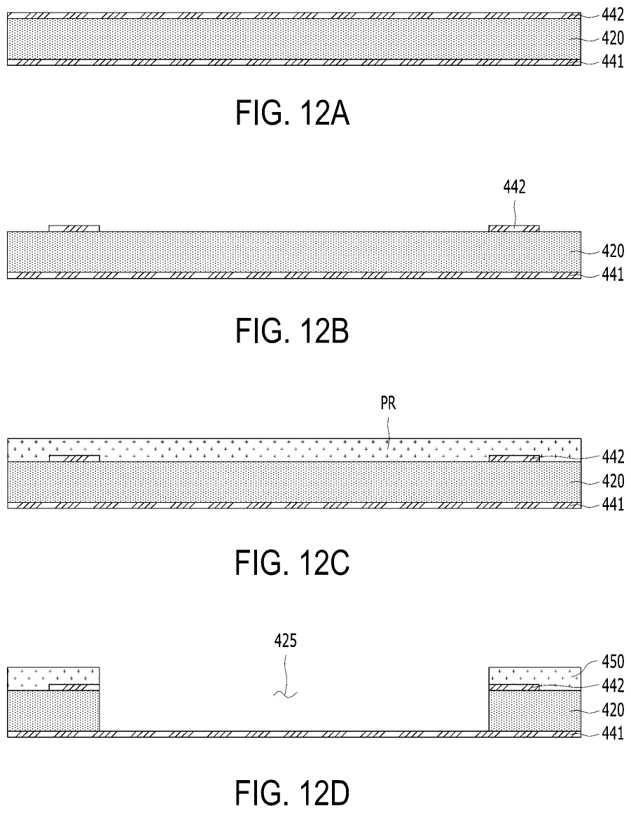

FIGS. 11 to 14 are views illustrating a metal molded article 400 and a method for manufacturing the same according to a fifth embodiment of the present disclosure. FIG. 11a is a plan view illustrating the metal molded article 400 according to the fifth embodiment, FIG. 11b is a sectional view taken along line A-A′ of FIG. 11a, FIG. 11c is a front view illustrating the metal molded article 400, and FIG. 11d is a rear view illustrating the metal molded article 400. FIGS. 12 to 14 are views illustrating the method for manufacturing the metal molded article 400 according to the fifth embodiment of the present disclosure.

Referring to FIG. 11, the metal molded article 400 includes a protruding tip portion 430 having a smaller cross-sectional area than a central portion of a body portion 410. The tip portion 430 is provided at a center of an end of the metal molded article 400.

Referring to FIG. 11, tip portions 430 are provided at opposite ends of the metal molded article 400. A first tip portion 431 provided at a first end of the metal molded article is made of a material different from that of the body portion 410, and a second tip portion 433 provided at a second end of the metal molded article is also made of a material different from that of the body portion 410. The central axis of each of the tip portions 330 is located on the central axis of the body portion 310.

The first tip portion 431 includes a protruding portion 431a protruding outward from the body portion 410 of the metal molded article 400 and a buried portion 431b located inside the body portion 410 of the metal molded article 400. Also, the second tip portion 433 includes a protruding portion 433a protruding outward from the body portion 410 of the metal molded article 400 and a buried portion 433b located inside the body portion 410 of the metal molded article 400. With the configuration of the buried portions 431b and 433b, the first and second tip portions 431 and 433 made of a material different from that of the body portion 410 are prevented from being separated from the body portion 410.

With reference to FIGS. 12 to 14, the method for manufacturing the metal molded article 400 according to the fifth embodiment of the present disclosure will be described.

Referring to FIG. 12a, first, a first mold 420 made of an anodic aluminum oxide film is prepared. A first seed layer 441 is provided under the first mold 420 made of the anodic aluminum oxide film, and a second seed layer 442 is provided on the first mold 420 made of the anodic aluminum oxide film. The first and second seed layers 441 and 442 are formed on and under the first mold 420 in advance for subsequent electroplating.

Referring to FIG. 12b, the second seed layer 441 is patterned. Then, referring to FIG. 12c, a photoresist PR is formed. Then, referring to FIG. 12d, the photoresist PR is patterned, and the anodic aluminum oxide film is etched using the patterned photoresist PR as a mask to form a first opening 425. The first mold 420 made of the anodic aluminum oxide film having the first opening 425 and a second mold 450 made of a photoresist film are provided. The second mold 450 made of the photoresist film is located on the first mold 420 made of the anodic aluminum oxide film.

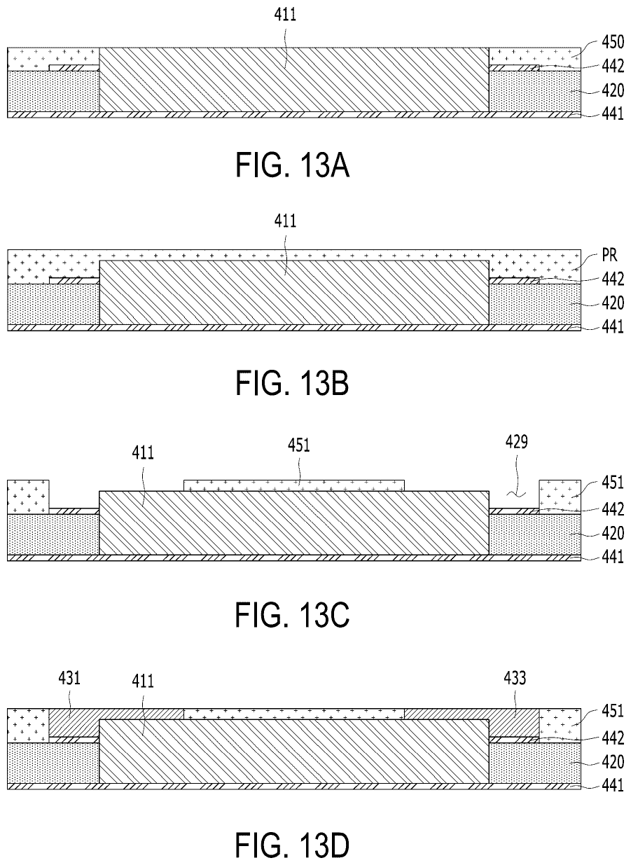

Referring to FIG. 13a, a first body portion 411 is formed in the first opening 425 by plating. Then, referring to FIG. 13b, a photoresist PR is formed.

Referring to FIG. 13c, a third mold 451 made of a photoresist film and having second openings 429 is formed by patterning the photoresist PR. The second openings 429 are formed by patterning the photoresist PR so that an upper surface of the first body portion 411 and an upper surface of the second seed layer 442 are exposed. Each of the second openings 429 has a stepped end formed due to a height difference between the upper surface of the first body portion 411 and the upper surface of the second seed layer 442.

Referring to FIG. 13d, a first tip portion 431 and a second tip portion 433 are formed in the second openings 429 by plating. Due to a stepped surface, a bonding area between the first and second tip portions 431 and 433 and the first body 411 is increased, so that the first and second tip portions 431 and 433 can be prevented from being separated more effectively. The first and second tip portions 431 and 433 include buried portions 431b and 433b and protruding portions 431a and 433a, respectively. The protruding portions 431a and 433a are formed to be thicker than the buried portions 431b and 433b, and extended thickness surfaces of the protruding portions 431a and 433a are bonded to the first body portion 411, so that the first and second tip portions 431 and 433 can be prevented from being separated more effectively.

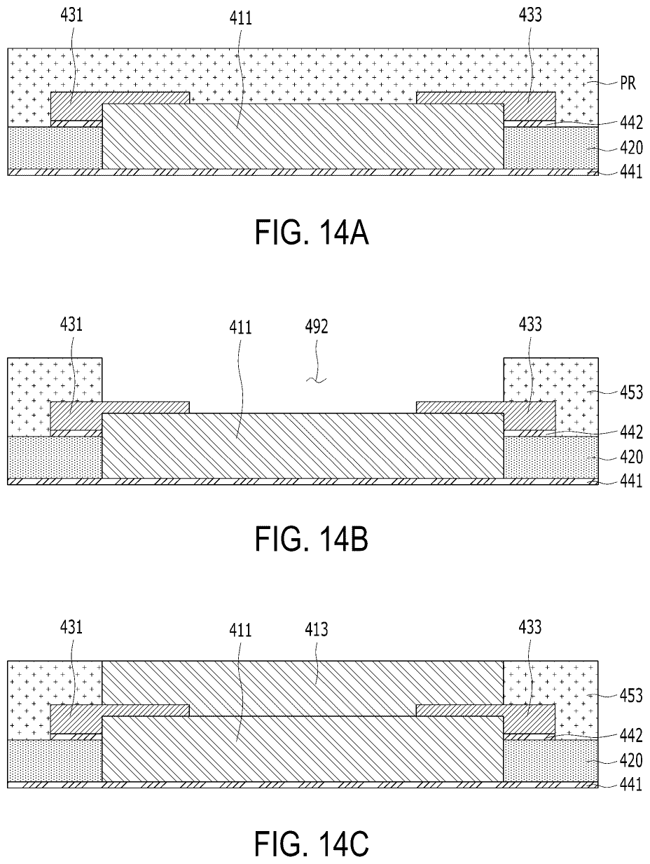

Then, referring to FIG. 14a, a photoresist PR is formed. Then, referring to FIG. 14b, a fourth mold 453 made of a photoresist film and having a third opening 429 is formed by patterning the photoresist PR. The buried portions 431b and 433b of the first and second tip portions 431 and 433 are exposed through the third opening 429. Then, referring to FIG. 14c, a second body portion 413 is formed in the third opening 429 by plating. Then, the fourth mold 453 made of the photoresist film, the first mold 420 made of the anodic aluminum oxide film, and the first and second seed layers 441 and 442 are removed, thereby completing a metal molded article 400. The metal molded article 400 thus manufactured has the first and second tip portions 431 and 433 at opposite ends thereof, respectively. The first and second tip portions 431 and 433 are made of a material different from that of the body portion 410.

In the fifth embodiment of the present disclosure, it has been described that the buried portions 431b and 433b are spaced apart from each other and are formed separately. However, in a modified example of the fifth embodiment, the buried portions 431b and 433b may be connected to each other so that the first and second tip portions 431 and 433 are configured as one body. Thus, in the modified example of the fifth embodiment, the extended thickness surfaces of the protruding portions 431a and 433a function as locking steps, thereby preventing the first and second tip portions 431 and 433 from being separated more effectively.

A first side surface area 11 of the metal molded article 400 is formed using the first mold 420 made of the anodic aluminum oxide film, and a second side surface area 13 of the metal molded article 400 is formed using the second mold 450, the third mold 451, and the fourth mold 453 made of the photoresist film. The first side surface area 11 formed using the first mold 420 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from a first surface (upper surface) to a second surface (lower surface) of the metal molded article.

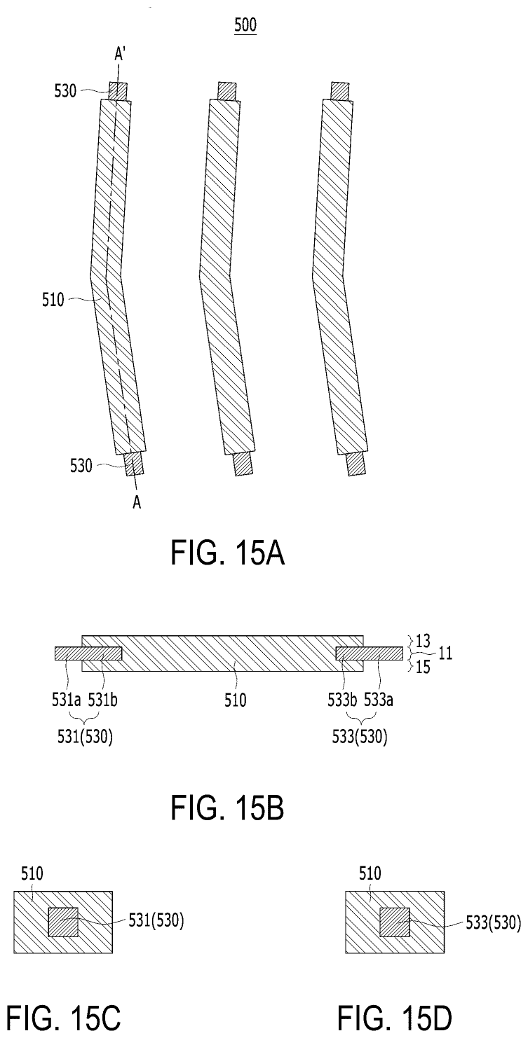

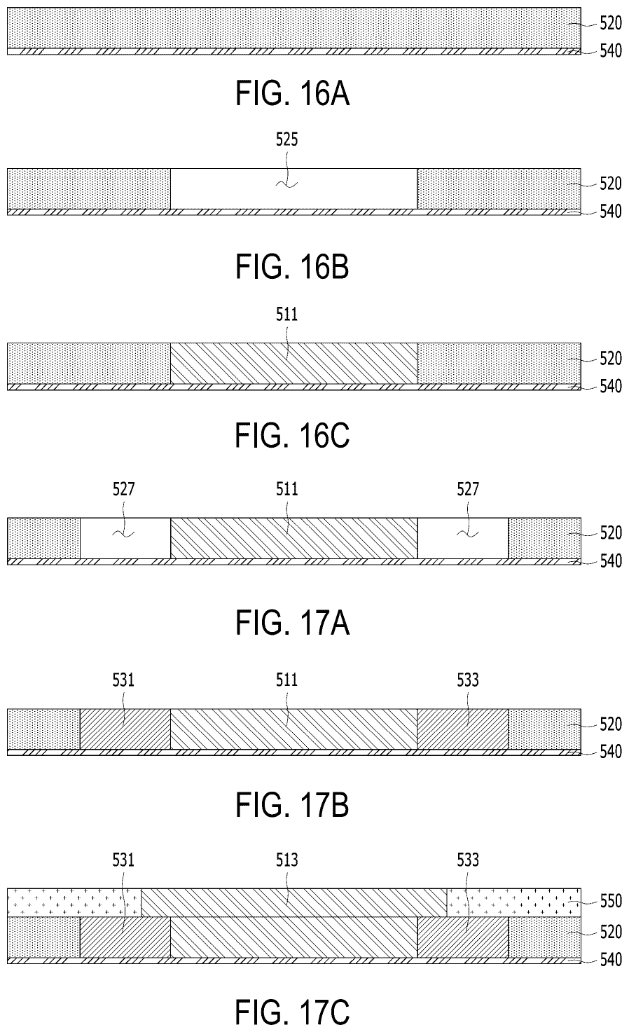

FIGS. 15 to 18 are views illustrating a metal molded article 500 and a method for manufacturing the same according to a sixth embodiment of the present disclosure. FIG. 15a is a plan view illustrating the metal molded article 500 according to the sixth embodiment, FIG. 15b is a sectional view taken along line A-A′ of FIG. 15a, FIG. 15c is a front view illustrating the metal molded article 500, and FIG. 15d is a rear view illustrating the metal molded article 500. FIGS. 16 to 18 are views illustrating the method for manufacturing the metal molded article 500 according to the sixth embodiment of the present disclosure.

Referring to FIG. 15, the metal molded article 500 includes a protruding tip portion 530 having a smaller cross-sectional area than a central portion of a body portion 510. The tip portion 530 is provided at a center of an end of the metal molded article 500.

Tip portions 530 are provided at opposite ends of the metal molded article 500. A first tip portion 531 provided at a first end of the metal molded article is made of a material different from that of the body portion 510, and a second tip portion 533 provided at a second end of the metal molded article is also made of a material different from that of the body portion 510. The central axis of each of the tip portions 530 is located on the central axis of the body portion 510.

The first tip portion 531 includes a protruding portion 531a protruding outward from the body portion 510 of the metal molded article 500 and a buried portion 531b located inside the body portion 510 of the metal molded article 500. Also, the second tip portion 533 includes a protruding portion 533a protruding outward from the body portion 510 of the metal molded article 500 and a buried portion 533b located inside the body portion 510 of the metal molded article 500. With the configuration of the buried portions 531b and 533b, the first and second tip portions 531 and 533 made of a material different from that of the body portion 510 are prevented from being separated from the body portion 510.

With reference to FIGS. 16 to 18, the method for manufacturing the metal molded article 500 according to the sixth embodiment of the present disclosure will be described.

Referring to FIG. 16a, first, a first mold 520 made of an anodic aluminum oxide film is prepared. A seed layer 540 is provided under the first mold 520 made of the anodic aluminum oxide film. The seed layer 540 is formed under the first mold 520 in advance for subsequent electroplating.

Referring to FIG. 16b, a first opening 525 is formed in the first mold 520 made of the anodic aluminum oxide film. The first opening 525 may be formed by removing at least a portion of the first mold 520 made of the anodic aluminum oxide film.

Referring to FIG. 16c, a first body portion 411 is formed in the first opening 425 by plating.

Referring to FIG. 17a, second openings 527 are formed in the first mold 520 made of the anodic aluminum oxide film. The second openings 527 may be formed by removing at least portions of the first mold 520 made of the anodic aluminum oxide film.

Referring to FIG. 17b, the first and second tip portions 531 and 533 are formed in the second openings 527 by plating.

Referring to FIG. 17c, a photoresist is formed. A second mold 550 made of a photoresist film is formed by patterning the photoresist. The length of an opening of the second mold 550 is formed longer than that of the first body portion 411. Then, a second body portion 513 is formed in the opening of the second mold 550 made of the photoresist film by plating.

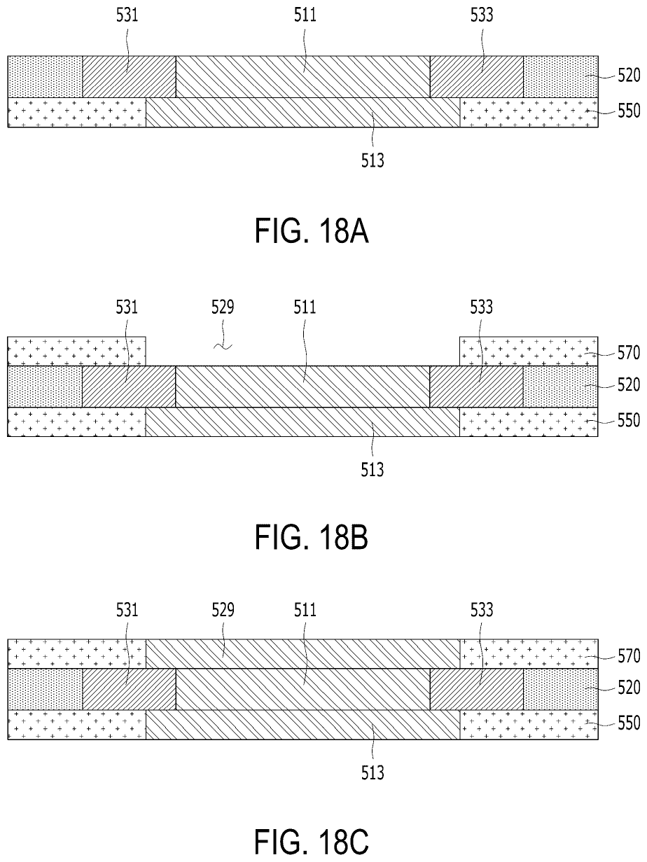

Referring to FIG. 18a, the product thus manufactured in FIG. 17c is reversed and then seed layer 540 is removed.

Referring to FIG. 18b, a photoresist is formed. A third mold 570 made of a photoresist film is formed by patterning the photoresist. The third mold 570 made of the photoresist film has a third opening 529. The length of the third opening 529 is formed longer than that of the first body portion 511.

Referring to FIG. 18c, a third body portion 515 is formed in the third opening 529 by plating. Then, the second and third molds 550 and 570 made of the photoresist film and the first mold 520 made of the anodic aluminum oxide film are removed, thereby completing a metal molded article 500. The metal molded article 500 thus manufactured has the first and second tip portions 531 and 533 at opposite ends thereof, respectively. The first and second tip portions 531 and 533 are made of a material different from that of the body portion 510.

The metal molded article 500 includes a first side surface area 11 located at a first height of a side surface of the metal molded article 400, a second side surface area 13 located above the first side surface area, and a third side surface area 15 located below the first side surface area. The first side surface area 11 protrudes further in the longitudinal direction than the second and third side surface areas 13 and 15. The first side surface area 11 of the metal molded article 500 is formed using the first mold 520 made of the anodic aluminum oxide film, and the second and third side surface areas 13 and 15 of the metal molded article 400 are formed using the second and third molds 550 and 570 made of the photoresist film. The first side surface area 11 formed using the first mold 520 made of the anodic aluminum oxide film is provided with a fine trench 88 formed by pores of the anodic aluminum oxide film (see FIG. 19). In other words, the first side surface area 11 is provided with a plurality of fine trenches 88 formed side by side in a long groove shape extending from a first surface (upper surface) to a second surface (lower surface) of the metal molded article. Since the first side surface area 11 is an area where the protruding first and second tip portions 531 and 533 having a smaller cross-sectional area than the central portion of the body portion 510 are formed, a plurality of fine trenches 88 are formed side by side on a side surface of each of the first and second tip portions 531 and 533 in a long groove shape extending from the first surface (upper surface) to the second surface (lower surface) of the metal molded article.

As described above, the metal molded article is characterized in that it is manufactured using a composite mold including a first mold made of an anodic aluminum oxide film and a second mold made of a patternable material. Preferably, the manufacture of the metal molded article is achieved by manufacturing the composite mold in advance and then forming a metal filler in openings of the composite mold. The metal filler may be formed by sequentially stacking the first mold made of the anodic aluminum oxide film and the second mold made of the patternable material according to a process order.

According to the embodiment of the present disclosure, the use of a combination of the first mold made of the anodic aluminum oxide film and the second mold made of the patternable material as a mold for electroplating makes it possible to compensate for an insufficient height of the first mold made of the anodic aluminum oxide with the second mold made of the patternable material. In addition, when using only the first mold made of the anodic aluminum oxide film, it may be difficult to manufacture a metal molded article having a three-dimensional shape in the height direction. However, the use of a combination of the first mold made of the anodic aluminum oxide film and the second mold made of the patternable material makes it easy to manufacture a metal molded article having a three-dimensional shape in the height direction.

Although the exemplary embodiments of the present disclosure have been described for illustrative purposes, those skilled in the art will appreciate that various modifications, additions, and substitutions are possible, without departing from the scope and spirit of the present disclosure as disclosed in the accompanying claims.

### DESCRIPTION OF THE REFERENCE NUMERALS IN THE DRAWINGS

100: metal molded article
110: body portion
120: first mold
130: tip portion
140: seed layer
150: second mold

1-5. (canceled)

6. A metal molded article having a first surface, a second surface opposite to the first surface, and a side surface connecting the first surface and the second surface to each other,
wherein a side surface area located at at least a partial height of the side surface comprises a fine trench, unlike a side surface area located at another height.

7. The metal molded article of claim 6, wherein at least one end of the metal molded article comprises a protruding tip portion having a cross-sectional area smaller than a cross-sectional area of a central portion of a body portion.

8. The metal molded article of claim 7, wherein the tip portion is made of a material different from a material of the body portion.

9. The metal molded article of claim 7, wherein the tip portion has the same width as the central portion of the body portion, but has a lower height than the central portion of the body portion.

10. The metal molded article of claim 7, wherein the tip portion has the same height as the central portion of the body portion, but has a narrower width than the central portion of the body portion.

11. The metal molded article of claim 7, wherein the tip portion is provided at a corner of the end of the metal molded article.

12. The metal molded article of claim 7, wherein the tip portion is provided at a center of the end of the metal molded article.

13. The metal molded article of claim 7, wherein the tip portion is made of a material having a higher hardness than the body portion.

14-26. (canceled)
